(19) United States
(12) Patent Application Publication
(10) Pub. No.: US 2009/0228966 A1
(43) Pub. Date: Sep. 10, 2009

(54) Authentication Method for Wireless Transactions

(75) Inventors: Horatiu Nicolae Parfene, Wellington (NZ); Antony John Williams, Wellington (NZ)

Correspondence Address: NIXON & VANDERHYE, PC, 901 NORTH GLEBE ROAD, 11TH FLOOR, ARLINGTON, VA, 22203, US

(73) Assignee: Fronde Anywhere Limited, Wellington (NZ)

(21) Appl. No.: 12/085,772

(22) PCT Filed: May 17, 2007
(86) PCT No.: PCT/NZ2007/000115

§ 371 Date: Feb. 2, 2009

(30) Foreign Application Priority Data
May 18, 2006 (NZ) 547322

(51) Int. Cl. H04L 9/32; G06F 21/00; G06Q 40/00

(52) U.S. Cl. 726/7; 726/9; 705/35

(57) ABSTRACT

An authentication method in which a token is associated with a mobile device and a user of a remote computer, it is established that the token at the mobile device and remote computer match and the token at the mobile device and remote computer is updated during a connection. Preferably a two factor authentication method is employed in which password authentication is the second factor.

### FIELD OF THE INVENTION

This invention relates to an authentication method for use in wireless transactions and in particular, although not exclusively, to commercial transactions over a cellular communications network. The method is preferably employed in a two factor authentication method utilising a user password and an authentication token.

### BACKGROUND OF THE INVENTION

There is an increasing demand for mobile services in relation to commercial or sensitive transactions such as mobile banking. Whilst services such as Internet banking commonly only require one factor authentication (i.e. a password) greater security is considered desirable for mobile banking via a cellular communications network due to the higher perceived risk of wireless communications.

Two factor authentication provides stronger protection as this requires two methods of authentication (e.g. a security token or key in combination with a user password). A number of methods for generating and distributing security tokens for use in wireless transactions are known as described in WO02/19593, WO01/17310 and WO03/063411.

These methods employ single use tokens (which must be applied for to conduct each transaction) or persistent tokens. Single use tokens are inconvenient in requiring a token to be requested for each transaction. Persistent tokens pose a security risk should a third party obtain the token whilst it may still validly be used.

It would be desirable to provide an authentication method requiring minimal user input which provides strong security. It would be desirable for the authentication process to be activatable via a range of channels requiring minimal user involvement. It would also be desirable if the process could be used with a wide range of mobile devices. The authentication process should also provide good protection against spoofing, phishing, interception, software decompilation, software substitution, manipulation of data or software and accessing of a security token. It should also minimise possible repudiation of a transaction by a user.

### EXEMPLARY EMBODIMENTS

A number of embodiments are described herein and the following embodiments are to be read as non-limiting exemplary embodiments only.

According to one exemplary embodiment there is provided a method of providing authentication of a transaction between a mobile device and a remote computer via a wireless communications link, the method comprising:
i. performing a first method of authentication comprising:
   a. verifying that a token stored in the mobile device corresponds with a token associated with that device at the remote computer; and
   b. sending a new token from the remote computer to the mobile device during an active session to replace the existing token and associating the new token with the mobile device at the remote computer; and
ii. performing a second method of authentication prior to processing the transaction.

There is also provided software for implementing the method and a mobile device and a remote computer running the software.

According to another embodiment there is provided a mobile commerce system comprising:
a computer including memory for storing security tokens associated with user identification information; and
a communications gateway for conveying authentication information from a mobile network to the computer,
wherein the computer is adapted to verify a token associated with a user during a session with a mobile device and to generate a new token, store it in memory and forward it to the mobile device via the communications gateway and to authenticate a transaction based upon the token received and a second authentication code received from the mobile device.

There is further provided a mobile device and a computer for use in the system.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention.

FIG. 1 shows a schematic diagram of a mobile commerce system suitable for implementing the authentication method of the invention.

### DESCRIPTION OF EMBODIMENTS OF THE INVENTION

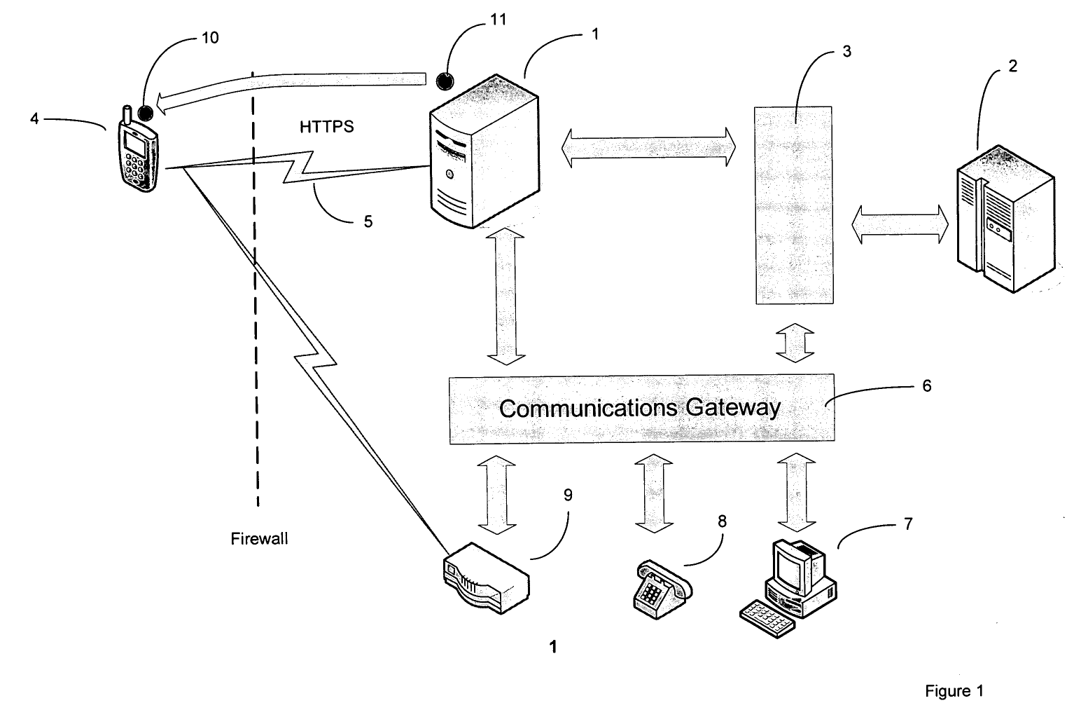

FIG. 1 shows schematically one possible system for implementing the authentication method of the invention. The authentication method involves associating a token with a mobile device and a user at a remote computer, establishing that the token at the mobile device and remote computer match and updating the token at the mobile device and remote computer during a connection. Preferably a two factor authentication method is employed. In a preferred embodiment traditional password authentication is the second factor.

Referring to FIG. 1 a mobile banking implementation is described by way of example. A remote computer 1 is connected to a client computer system 2 (in this case a core banking system) via an Internet banking business layer 3 (this may be a software layer within the client computer system 2 or software hosted on an intermediate computer). Remote computer 1 may communicate with a mobile device 4 via a wireless link 5 (this link would typically be via a mobile telecommunications provider).

Remote computer 1 and business layer 3 are connected to telecommunications gateway 6 that facilitates communications with remote computers 7, telephones 8 and SMS server 9 to provide Internet banking, telephone banking and SMS communications.

To enable mobile banking a user may request the service through one of a number of channels as follows:
1. At a bank—a user may the visit and branch of their bank, validate their identity and have an application downloaded to their mobile wireless device 4 wirelessly, via removable media, via a data line etc.
2. SMS—a user may send an SMS message requesting mobile banking, the bank may verify the credentials and, if satisfied, instruct remote computer 1 to send the mobile banking application to the client.
3. Telephone—a user may telephone the bank requesting mobile banking. Upon verifying user credentials remote computer 1 may be instructed to send the mobile banking application to the client.
4. Internet banking—during an Internet banking session a user may request mobile banking services. As the credentials of the user have been verified during the logon to Internet banking the mobile banking application may be automatically sent to the user.

It will be appreciated that an application for mobile banking services may be made in a variety of ways and the above are exemplary only.

The mobile banking application may be delivered in a variety of ways. It could be delivered directly from remote computer 1 to mobile wireless device 4. However, one preferred method is to send a WAP message to mobile device 4 incorporating a URL enabling the application to be downloaded. The URL may be specific to a user to provide additional security. The user may then establish a secure https connection and download the application from the URL. It will be appreciated that a variety of methods may be employed to securely deliver the mobile banking application.

The mobile banking application may be delivered, activated and used in a number of ways. Two possible embodiments will be described below.

According to a first embodiment, when the mobile banking application is delivered it incorporates a security token 10. An identical security token 11 is stored at remote computer 1 and associated with the user ID (username, telephone number etc.). When a user attempts to access mobile banking services using wireless mobile device 4 the mobile banking application establishes a connection with remote computer 1. During the establishment of this connection remote computer 1 establishes whether token 10 corresponds with token 11 associated with the user ID at remote computer 1. This process occurs behind the scenes and does not require user input. Remote computer 1 preferably also checks that no other connection has been established utilising the same token. This cheek may be conducted during establishment of a connection and/or during a session. It is preferred that the token is associated with the user phone number as this associates the token with a specific device. Whilst it is preferred that the token is validated during establishment of the connection it will be appreciated that the token could be validated once a connection is established also.

Once token 10 is validated remote computer 1 generates a new token which is associated with the user ID at remote computer 1 and sent to mobile device 4 to be substituted for the previous token. In this way the token may only be used for one session and interception of a token will not allow a subsequent connection to be established.

The mobile banking application supplied to the mobile wireless device 4 preferably provides a high-level of security. Features that may achieve this include:
1. obfuscated code (i.e. compressed and unintelligible code)
2. Virtual machines (i.e. each application runs in its own space without interaction with other components)
3. pre-verified code (i.e. checked to ensure it cannot override machine classes)

To achieve these features it is preferred that the application is written in Java J2ME code.

The token should be difficult to access or manipulate. It is preferred at the token is embedded within the mobile banking application in a manner that makes it difficult to access or manipulate. Preferably the token is stored as byte code within the mobile banking application stored on the wireless mobile device 4.

Preferably, a second authentication method is employed in combination with the authentication token method described above. A preferred second authentication method is the submission of a user password. This is aligned with existing Internet banking security and so requires minimal adaptation. Once a secure https connection is established according to the method above the mobile application running on wireless mobile device 4 may require entry of a user password. Once a user enters their password this may be communicated via a wireless link 5 to remote computer 1. The password may be validated at remote computer 1 or conveyed to client computer system 4 for authentication.

For an Internet banking application banks generally prefer that password authentication is performed by client computer system 4. In other applications the second authentication method may be selected from the range of authentication methods known to those skilled in the art. This method of two factor authentication has the advantage that the token and password are sent at different times (i.e. the token is sent during the establishment of a connection and the password is sent during a secure session) and in different data streams. This makes it difficult to intercept both the token and password.

According to a second embodiment a user specific URL is sent to a user to download the application in response to a request for the service. A user specific signature is inserted into the application associated with that user. The user specific signature may in one preferred embodiment be included in a JAR file.

A user may then download the application including the user specific signature from the user specific URL and run the application on their mobile device. The application first checks to see whether a URL is stored in memory of the mobile device corresponding to the user specific URL. If no URL is located or the URL is different then the application requires activation to run. In this way each time the application is run it checks that the instance of the application installed is correct.

This prevents a malicious application being substituted and requires activation if a new version of the application is downloaded.

If the URLs match then the user is prompted to provide an activation code previously provided via a secure channel. The entered activation code and the user specific signature are sent to the remote computer and if they match values for the user stored at the remote computer then the remote computer validates the request and sends a token to the remote mobile device. The token is preferably stored as obfuscated byte code within the application stored on the mobile device but could be stored elsewhere.

In use a user enters a password and the password, user specific signature and token are sent to the remote computer for authentication. Once authenticated a new token is sent to the mobile device to replace the old token and one or a session of transactions may be conducted (depending upon configuration).

Once the authentication tests have been satisfied a user may conduct Internet banking transactions such as bill payments, funds transfer, obtaining transaction histories and viewing account balances. However, it will be appreciated that in other applications a wide range of commercial or other transactions could be conducted.

There is thus provided and method and system that can be supplied to a wide range of existing wireless mobile devices without requiring any cryptographic functionality to be provided in the phone. The method can be applied easily to existing systems without major modification or additional system components; making the method cost effective to deploy. The method may be easily deployed to and used by customers. The additional security provided by the token is transparent to the user. Including a user specific signature in the application provides a third authentication factor and use and storage of the user specific download URL ties the application to the device. The method provides a high-level of security as the separate modes of processing the two factors makes it difficult to intercept data or interfere with security. Further, the software makes it extremely difficult to access or change software or data. The tied relationship between a specific mobile device and a token restricts third parties from attempting access from another device and limits possible repudiation of a transaction by a user. Although the method and system of the invention had been described in relation to a mobile banking application it will be appreciated that the method of the invention may find a wide range of applications beyond the supplication.

While the present invention has been illustrated by the description of the embodiments thereof, and while the embodiments have been described in detail, it is not the intention to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the applicant's general inventive concept.

1. A method of providing authentication of a transaction between a mobile device and a remote computer via a wireless communications link, the method comprising:
i. performing a first method of authentication comprising:
a. verifying that a token stored in the mobile device corresponds with a token associated with that device at the remote computer; and
b. sending a new token from the remote computer to the mobile device during an active session to replace the existing token and associating the new token with the mobile device at the remote computer; and
ii. performing a second method of authentication prior to processing the transaction.

2. A method as claimed in claim 1 wherein the second method of authentication is performed separately to authentication of the token.

3. A method as claimed in claim 1 wherein the second method of authentication is performed after the token has been authenticated.

4. A method as claimed in claim 1 wherein the second method of authentication is performed before the token has been authenticated.

5. A method as claimed in claim 1 wherein authentication data for the second method of authentication is sent from the mobile device to the remote computer system in a separate data stream.

6. A method as claimed in claim 2 wherein the second method of authentication occurs over a secure connection.

7. A method as claimed in claim 5 wherein the secure connection uses https protocol.

8. A method as claimed in claim 1 wherein the second method of authentication is sending a password from the mobile device to the remote computer.

9. A method as claimed in claim 1 wherein the token is authenticated during the establishment of a wireless communications connection.

10. A method as claimed in claim 9 wherein the password is authenticated at the remote computer.

11. A method as claimed in claim 7 wherein the password is authenticated by a customer computer system linked to the remote computer system.

12. A method as claimed in claim 9 wherein the customer computer system is a banking computer system.

13. A method as claimed in claim 1 wherein a check is conducted to ensure that the token sent to the remote computer is not in use in another session.

14. A method as claimed in claim 13 wherein the check is conducted during authentication.

15. A method as claimed in claim 14 wherein the check is conducted during an authenticated session.

16. A method as claimed in claim 1 wherein an application is downloaded to the mobile device which manages authentication of the token with the remote computer.

17. A method as claimed in claim 16 wherein the token is stored within the application.

18. A method as claimed in claim 17 wherein the application contains obfuscated code and the token is stored within the obfuscated code.

19. A method as claimed in claim 16 wherein the application runs as a virtual machine.

20. A method as claimed in claim 16 wherein the application is written in J2ME.

21. A method as claimed in claim 16 wherein the application is downloaded via a wireless link.

22. A method as claimed in claim 21 wherein a URL link is sent to the mobile device in a WAP message and the application is downloaded upon activation of the URL link.

23. A method as claimed in claim 22 wherein the WAP message is sent in response to a request from a user during an internet banking session.

24. A method as claimed in claim 22 wherein the WAP message is sent in response to a SMS message from a user.

25. A method as claimed in claim 22 wherein the URL link is a unique URL address associated with the mobile device.

26. A method as claimed in claim 16 wherein a user specific signature is inserted into the application downloaded to the mobile device.

27. A method as claimed in claim 26 wherein the user specific signature is stored in a JAR file.

28. A method as claimed in claim 16 wherein the downloaded application stores the URL used to download the application in memory of the mobile device.

29. A method as claimed in claim 28 wherein the application checks the memory of the mobile device to check the URL used to download the application and if not present or different to a URL associated with the application then the application requires entry of an activation code to run.

30. A method as claimed in claim 29 wherein the activation code is a code provided to a user associated with the mobile device.

31. A method as claimed in claim 29 wherein upon entry of an activation code by a user the activation code and the user specific signature stored in the application are sent to the remote computer for validation.

32. A method as claimed in claim 31 wherein a token is sent to the mobile device if the activation code and user specific signature are validated for the mobile device.

33. A method as claimed in claim 1 wherein the method is performed to enable an online banking transaction to be performed.

34. A method as claimed in claim 33 wherein the online banking transaction is selected from the group of: bill payment, funds transfer, obtain transaction history and view account balance.

35. Software for a mobile device for implementing the mobile device side of authentication according to the method of claim 1.

36. A mobile device including software as claimed in claim 35.

37. Software for a remote computer for implementing the remote computer side of authentication according to the method of claim 1.

38. A remote computer including software as claimed in claim 37.

39. A mobile commerce system configured to perform the method of claim 1.

40. A mobile commerce system comprising:
i. a computer including memory for storing security tokens associated with user identification information; and
ii. a communications gateway for conveying authentication information from a mobile network to the computer,
wherein the computer is adapted to verify a token associated with a user during a session with a mobile device and to generate a new token, store it in memory and forward it to the mobile device via the communications gateway and to authenticate a transaction based upon the token received and a second authentication code received from the mobile device.

41. A mobile wireless communications device configured to store an authentication token, transmit the token over a wireless link at the initiation of a session and to replace the token with a new token received during the session.

42. A mobile wireless communications device configured to perform the method of claim 1.

43. A computer platform in communication with a wireless communications service, the computer platform configured to store a plurality of tokens associated with a plurality of users, to verify whether a token received during initiation of a session corresponds with a token associated with that user and to generate a new token during a session, associate it with the respective user and forward it to a mobile device associated with the user.

44. A computer platform configured to perform the method of claim 1.
